(19) United States
(12) Patent Application Publication
(10) Pub. No.: US 2006/0044803 A1
(43) Pub. Date: Mar. 2, 2006

(54) LED light source

(75) Inventor: Nicholas Edwards, Hampshire (GB)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: CUSTOM INTERCONNECT LTD., Andover (GB)

(21) Appl. No.: 11/181,674

(22) Filed: Jul. 14, 2005

(30) Foreign Application Priority Data
Sep. 2, 2004 (GB) GB0419467.6

(51) Int. Cl. F21V 29/00

(52) U.S. Cl. 362/294

(57) ABSTRACT

An LED light source including a plurality of LED dies, a corresponding number of heat sinks each having an integral light reflector on which a die is mounted, and a dielectric substrate on one side of which the heat sinks are contiguously mounted in spaced apart relationship with the light reflector remote the dielectric substrate. The heat sinks each include an island of material having high thermal conductivity and of sufficient thickness to ensure that heat generated in the die is distributed substantially uniformly over a contact region between the substrate and the heat sink.

### FIELD OF THE INVENTION

This invention relates to LED (Light Emitting Diode) light sources and more especially but not exclusively it relates to LED UV (Ultra Violet) light sources.

### BACKGROUND OF THE INVENTION

Light Emitting Diodes (LEDs) have been available for many years and are widely used as indicators on instruments and apparatus.

Due to progressive developments in the field of semiconductor processing technology, LEDs are now produced with significantly higher light output powers and in quite a wide range of wavelengths (colours) and while reds yellows and greens have been widely available for some time, shorter wavelength devices in the blue, violet and near ultra-violet spectrum are now also being manufactured. So much so that these developments have now opened up possibilities for LEDs to be used for illumination rather than merely as indicators. However the use of LEDs for this purpose still poses certain problems.

Light output from individual LEDs is still comparatively small but since LED devices themselves are quite small, in known apparatus they are sometimes grouped to form an LED array. This clearly provides more light output, and to increase the light output flux density, bare LED dies without any associated package have been used, which permits a high packing density.

However, since LEDs are only about 20% efficient, about 80% of the input energy being converted to heat rather than light, with this known apparatus, heat dissipation is a problem exacerbated by high LED packing densities. As a result, if the heat produced is not effectively dissipated, with high packing densities the LEDs cannot be driven hard to produce a desirably high light output because device failure or shortened life would result.

### SUMMARY OF THE INVENTION

It is an object of this invention to provide an LED light source wherein the forgoing problems are mitigated at least partly whereby increased light can be made available which is useful for general illumination purposes, or in the case of UV light to effect the curing of adhesives, coatings, inks and the like.

According to the present invention, an LED light source comprises a plurality of LED dies, a corresponding number of heat-spreading mounts each having an integral light reflector on which a die is mounted, and a dielectric substrate on one side of which the said mounts are contiguously formed in spaced apart relationship, wherein the said mounts each comprise an island of material having high thermal conductivity and of sufficient thickness to ensure that heat generated in the die is spread substantially laterally over a contact region between the said substrate and the said mounts.

By using reflectors which are thick enough to serve also as effective heat spreaders, the dies may be driven harder thereby to facilitate the production of a correspondingly higher light output without causing LED degradation due to hot spots which might otherwise occur.

The said mounts may comprise islands of copper in which the light reflectors are formed.

Each light reflector may comprise a concave reflector surface on which a die is mounted.

The islands of copper may be plated onto the dielectric substrate and may be machined to form the concave reflector surfaces.

The underside of the dielectric substrate remote the dies may be plated with copper to facilitate good thermal contact with a heat sink.

The heat sink may be copper, or aluminum, or other high conductivity metal.

The dielectric material may be ceramic.

The dies may be encapsulated in a gel material having a refractive index closer to material of the dies than air so as to increase light output intensity from the array.

### BRIEF DESCRIPTION OF THE DRAWINGS

One embodiment of the invention will now be described by way of example only with reference to the accompanying drawings (not to scale) in which corresponding parts of the Figures shown bear the same numerical designations and in which:

FIG. 1 is a somewhat schematic sectional side view on a line A-A, as shown in FIG. 2, of a UV LED array;

FIG. 2 is a plan view of the array shown in FIG. 1; and

FIG. 3 is a circuit diagram of the array of FIGS. 1 & 2.

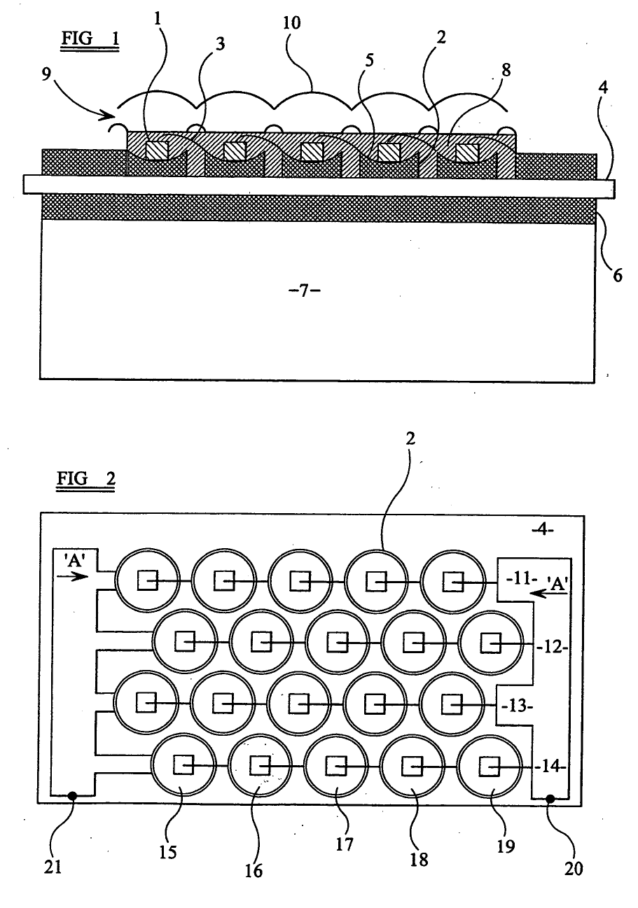

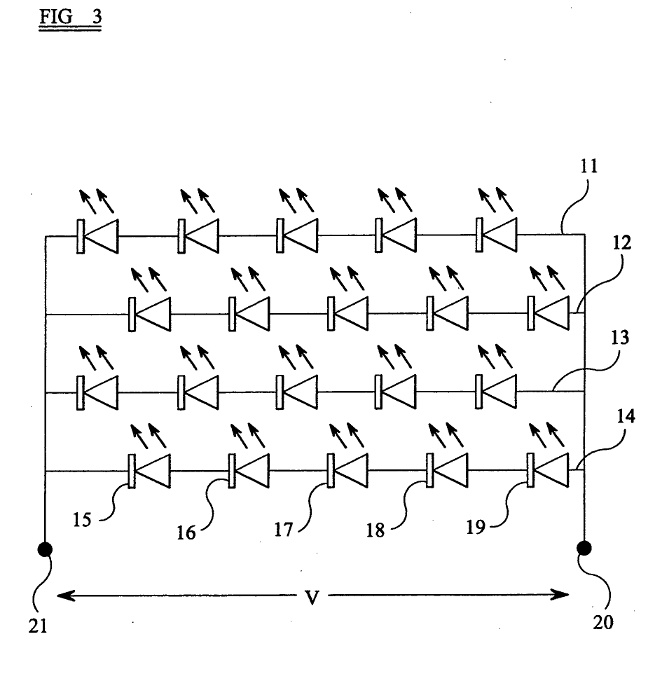

### DETAILED DESCRIPTION OF THE INVENTION

Referring now to the drawings, a plurality of UV LED dies 1, each supported on a copper heat spreader mount 2, and having electrical connector wires 3, is carried by a thin ceramic substrate 4.

The individual heat spreader mounts 2, are created by a thick copper plating process on the thin ceramic substrate 4. Each mount 2, is approximately 280 μm thick and is 800 μm to 1000 μm in diameter. Although in this example the heat-sink reflector mounts 2, are of generally circular in plan shape, in alternative embodiments they may be hexagonal, square or rectangular. A machining process is then used to create a concave surface in the centre of each of the mounts 2. These concave surfaces are plated to create reflectors 5, which direct photons emitted from the sides of the LED dies 1, forwards so that they contribute to useful light output from the array rather than being absorbed as would be the case without reflectors 5. The mounts 2, thus serve as reflectors and also as heat spreaders, which are small enough to facilitate close packing of the dies 1, which they support, whilst having sufficient thermal capacity to prevent hot spots.

The reverse side of the ceramic substrate 4, is plated with a thick copper layer 6, in order to balance the structure. By using a copper layer 6, plated directly onto ceramic, interface materials are not required which might have a significant detrimental effect on the overall thermal conductivity. The plated copper layer 6, is attached to a large copper heat sink 7, using either a soldering process or a thermally conductive adhesive. The heat is removed from the heat sink 7, either by water-cooling systems, forced air-cooling, thermo-electric or other active cooling systems, or by natural conduction into other elements of the product or by convection.

The dies are covered with protective glob top gel 8, having a refractive index closer to that of the die than air. By reducing the difference between the refractive index of the die and its surroundings and by coating the die with a material with a closer refractive index to that of the die than air, more photons are transferred to the useful light output from the die and are not internally reflected. This glob top gel 8, thus contributes to an increase in the light output flux density from the dies 1.

While the reflectors are designed to redirect the photons being emitted from the sides of the die to the forward direction as collimated light, the photons from the front surface of the die are emitted across a wide arc, determined by the critical angle and refractive indices of the materials. This means that without the reflectors, the flux density being generated from the front faces of the die in the array would drop as an inverse square law, but by incorporating a micro-lens array 9, positioned above it, having lens elements 10, which align with the LED dies 1, the photons being emitted at relatively large angles from the normal are redirected forwards, to reduce the drop off in flux density as a function of the distance away from the die 1, which might otherwise occur.

In this embodiment, the dies 1, are connected to define a series/parallel matrix of dies comprising four rows 11, 12, 13, 14, connected in parallel with five serially couple dies in each row, such as the dies 15, 16 17, 18, and 19, in row 14, for example. The number of dies in each row will be determined in accordance with drive voltage requirements and thus if V is the drive voltage applied between common anode terminal 20, and common cathode terminal 21, the number N of dies in each row will be V/v where v is the voltage drop across each die which is typically between 2 volts and 4 volts. The total number of dies in an array will be determined in accordance with the application in view and may be just a few for low illumination requirements to several thousand as necessary to produce a high light output. Although in this embodiment the connection wires 3, are coupled to the anodes, it will be appreciated that alternatively this would be reversed with a top cathode connection.

Various modifications may be made to the embodiments herein described without departing from the scope of the invention and for example any of the materials used may be changed or modified provided the purpose is satisfied, as will be readily apparent to those skilled in the art.

Additionally attention is directed to our co-pending Patent Application No. GB0419464.3, filed Sep. 2, 2004 and entitled UV CURING APPARATUS (the contents of which are incorporated herein) in which apparatus is described which might advantageously embody a light source according to this invention using UV LED dies.

What is claimed is:

1. An LED light source comprising a plurality of LED dies, a corresponding number of heat-spreading mounts each having an integral light reflector on which a die is mounted, and a dielectric substrate on one side of which the said mounts are contiguously formed in spaced apart relationship, wherein the said mounts each comprise an island of material having high thermal conductivity and of sufficient thickness to ensure that heat generated in the die is spread substantially laterally over a contact region between the said substrate and the said mount.

2. A light source as claimed in claim 1, wherein the said mounts comprise islands of copper at least 200 μm thick in which the light reflectors are formed.

3. A light source as claimed in claim 1, wherein each light reflector comprises a concave reflector surface on which a die is mounted.

4. A light source as claimed in claim 3, wherein the islands of copper are plated onto the dielectric substrate and machined to form the concave reflector surfaces.

5. A light source as claimed in claim 1, wherein an underside of the dielectric substrate remote the dies is plated with copper to facilitate good thermal contact with a heat sink.

6. A light source as claimed in claim 5, wherein the heat sink is copper, aluminum, or other high thermally conductive metal.

7. A light source as claimed in claim 1, wherein the dielectric material is ceramic.

8. A light source as claimed in claim 1, wherein the dies are encapsulated in a gel material having a refractive index closer to material of the dies than air, so as to increase light output intensity.

9. A light source as claimed in claim 1, further comprising a micro-lens array positioned above the LED dies, having a matrix of lens elements which align with the said dies.

10. A light source as claimed in claim 1, and substantially as hereinbefore described with reference to the accompanying drawings.

11. Apparatus for UV curing including the light source of claim 1 and wherein the dies are chosen to produce light in the UV spectrum.

12. Apparatus for illumination including the light source of claim 1 and wherein the dies are chosen to produce light in the visible spectrum.
